(19) United States
(12) Patent Application Publication
(10) Pub. No.: US 2016/0049796 A1
(43) Pub. Date: Feb. 18, 2016

(54) APPARATUS AND METHOD FOR RECEIVING POWER WIRELESSLY, AND WIRELESS POWER SUPPLY SYSTEM USING THE SAME

(71) Applicant: SAMSUNG ELECTRO-MECHANICS CO., LTD., Suwon-si (KR)

(72) Inventors: Sang Ho CHO, Suwon-si (KR); Hyung Wook CHO, Suwon-si (KR); Sung Heum PARK, Suwon-si (KR); Chang Mok HAN, Suwon-si (KR); Jae Suk SUNG, Suwon-Si (KR); Jeong Man HAN, Suwon-si (KR); Ki Won CHANG, Suwon-si (KR)

(21) Appl. No.: 14/608,102

(22) Filed: Jan. 28, 2015

(30) Foreign Application Priority Data
Aug. 18, 2014 (KR) 10-2014-0107098

(51) Int. Cl. H02J 5/00; H02J 7/02; H02J 7/04; H04B 5/00

(52) U.S. Cl. CPC H02J 5/005; H04B 5/0037; H02J 7/025; H02J 7/045

(57) ABSTRACT

An apparatus for receiving power wirelessly may include a power receiving unit wirelessly receiving the power in a non-contact manner, a switching unit operating the power receiving unit, and a controlling unit controlling an output voltage by adjusting an switching-on operation of the switching unit.

### CROSS-REFERENCE TO RELATED APPLICATION

This application claims the priority and benefit of Korean Patent Application No. 10-2014-0107098 filed on Aug. 18, 2014, with the Korean Intellectual Property Office, the disclosure of which is incorporated herein by reference.

### BACKGROUND

The present disclosure relates to an apparatus and method for receiving power wirelessly, and a wireless power supply system for wirelessly supplying power using the same.

A wireless technology has been developed to perform various wireless functions from the transmission of data to the transmission of power. Recently, a technology for transmitting power wirelessly capable of charging an electronic device in a non-contact manner has become an important issue.

The technology for transmitting power wirelessly may provide a charging method for charging an electronic device without a physical connection between the electronic device and a charging device. Therefore, convenience in charging and a degree of freedom in the technology for transmitting power wirelessly expedite development of various applications for transmitting power wirelessly.

However, the apparatus for receiving and transmitting power wirelessly has a relatively complex structure in order to satisfy the required voltages of various electronic devices, and as a result, the efficiency of power transmission may be degraded. Thus, a need exists for providing an apparatus for receiving or transmitting power wireless having a relatively simple structure and an improved efficiency of power transmission.

### SUMMARY

An aspect of the present disclosure may provide an apparatus and method for receiving power wirelessly capable of adjusting an output voltage with a simple circuit configuration, and a wireless power supply system for wirelessly supplying power using the same.

According to an aspect of the present disclosure, an apparatus for receiving power wirelessly may include a power receiving unit wirelessly receiving the power in a non-contact manner, a switching unit operating the power receiving unit, and a controlling unit controlling an output voltage by adjusting an ON switching operation of the switching unit.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a configuration diagram illustrating a wireless power supply system for wirelessly supplying power according to an exemplary embodiment in the present disclosure;

FIG. 2 is a circuit diagram illustrating an example of an apparatus for transmitting power wirelessly according to an exemplary embodiment in the present disclosure;

FIG. 3 is a block diagram illustrating an example of an apparatus for receiving power wirelessly according to an exemplary embodiment in the present disclosure;

FIG. 4 is a block diagram illustrating an example of a controlling unit of FIG. 3;

FIG. 5 is a circuit diagram illustrating an example of the apparatus for receiving power wirelessly according to an exemplary embodiment in the present disclosure;

FIG. 6 is a graph illustrating a level of an output voltage depending on an initial value of a resonance current;

FIG. 7 is a flowchart illustrating a method for receiving power wirelessly according to an exemplary embodiment in the present disclosure; and

FIG. 8 is a flowchart illustrating an example of the step S720 of FIG. 7.

### DETAILED DESCRIPTION

Exemplary embodiments in the present disclosure will now be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

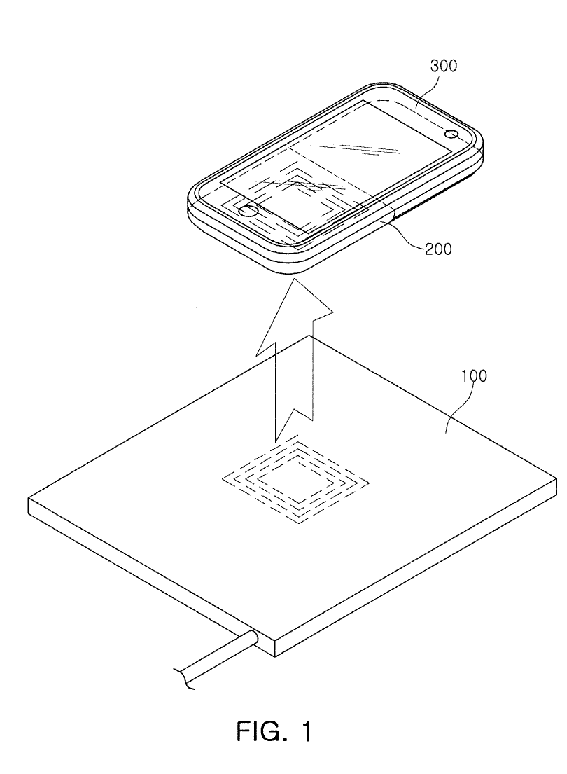

FIG. 1 is a configuration diagram illustrating a wireless power supply system for wirelessly supplying power according to an exemplary embodiment in the present disclosure.

As illustrated in FIG. 1, a wireless power supply system for wirelessly supplying power may include an apparatus for transmitting power wirelessly 100 and an apparatus for receiving power wirelessly 200.

The apparatus for transmitting power wirelessly 100 may wirelessly supply power to the apparatus for receiving power wirelessly 200 in a non-contact manner. The apparatus for transmitting power wirelessly 100 may include a power transmitting coil, and the power transmitting coil may have resonance with a power receiving coil of the apparatus for receiving power wirelessly 200 to wirelessly provide power to the power receiving coil.

Although the illustrated example illustrates one power transmitting coil, which is merely illustrative, the apparatus for transmitting power wirelessly 100 may include a plurality of power transmitting coils.

According to an exemplary embodiment in the present disclosure, the apparatus for transmitting power wirelessly 100 may be operated regardless of the apparatus for receiving power wirelessly 200. For example, the apparatus for transmitting power wirelessly 100 may be operated at a fixed frequency. For example, the apparatus for transmitting power wirelessly 100 may wirelessly supply power at the fixed frequency regardless of the type and number of the apparatuses for receiving power wirelessly 200. In the above-mentioned exemplary embodiment, the apparatus for receiving power wirelessly 200 may control an output voltage. For example, since the apparatus for transmitting power wirelessly 100 does not perform operations to control an output voltage, a separate control is not required for the apparatus for transmitting power wirelessly 100 even in a case in which the apparatus for transmitting power wirelessly 100 simultaneously and wirelessly supplies power to a plurality of apparatuses for receiving power wirelessly 200. Thus, a configuration and an operation thereof may be simplified.

The apparatus for receiving power wirelessly 200 may receive power wirelessly supplied from the apparatus for transmitting power wirelessly 100 in the non-contact manner. The apparatus for receiving power wirelessly 200 may supply the wirelessly received power to an electronic device 300.

The apparatus for receiving power wirelessly 200 may adjust a level of the voltage output by the apparatus for transmitting power wirelessly by adjusting a point in time of resonance with the apparatus for transmitting power wirelessly 100. For example, a predetermined operation for adjusting a level of output voltage may be performed by the apparatus for receiving power wirelessly 200. Therefore, the apparatus for transmitting power wirelessly 100 may be operated regardless of the number of apparatuses for receiving power wirelessly 200 or the voltage output by the apparatus for transmitting power wirelessly.

The apparatus for transmitting power wirelessly 100 and the apparatus for receiving power wirelessly 200 are not limited to a specific standard. For example, the apparatus for transmitting power wirelessly 100 and the apparatus for receiving power wirelessly 200 may be operated while satisfying a standard (e.g., A4WP) in which a communications scheme is preset, at the time of performing wireless charging. As another example, the apparatus for transmitting power wirelessly 100 and the apparatus for receiving power wirelessly 200 may be operated while satisfying a standard (e.g., WPC, PMA) in which a preset communications scheme is not present, at the time of performing the wireless charging.

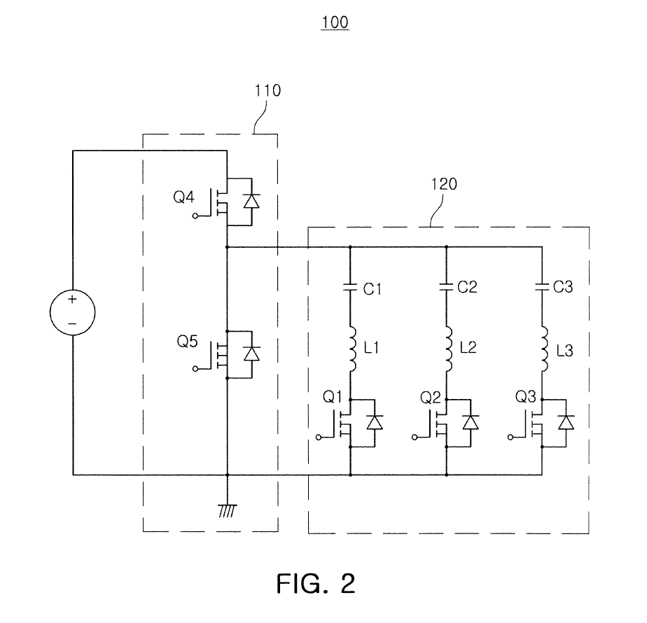

FIG. 2 is a circuit diagram illustrating an example of an apparatus for transmitting power wirelessly according to an exemplary embodiment in the present disclosure.

Referring to FIG. 2, an apparatus for transmitting power wirelessly 100 may include a switching unit 110 and a resonant tank 120.

The switching unit 110 may perform a switching operation at the fixed frequency regardless of the number of apparatuses for receiving power wirelessly 200 or the voltage output by the apparatus for transmitting power wirelessly. For example, switches Q4 and Q5 of the switching unit 110 may alternately perform a switching operation at a fixed frequency.

The resonant tank 120 may include power transmitting coils L1, L2, and L3. Although the illustrated example illustrates an LC resonant tank, the resonant tank may be implemented as various resonant tanks such as an LLC resonant tank, or the like according to exemplary embodiments in the present disclosure. Although the resonant tank 120 illustrates three power transmitting coils in the illustrated example, which is merely illustrative, the number of power transmitting coils is not limited thereto.

According to the related art, a scheme in which the apparatus for receiving power wirelessly 200 is operated at the same switching frequency as that of the apparatus for transmitting power wirelessly 100 without a separate control circuit and the switching frequency is varied depending on a voltage output from the apparatus for transmitting power wirelessly 100 has been used. In such a scheme according to the related art, when power is wirelessly supplied to the plurality of apparatuses for receiving power wirelessly 200, a problem in which the circuit is relatively complex and charging efficiency is decreased may occur.

Therefore, according to exemplary embodiments in the present disclosure, the apparatus for transmitting power wirelessly 100 may perform a predetermined operation and the apparatus for receiving power wirelessly 200 may perform controlling depending on the voltage output by the apparatus for transmitting power wirelessly, whereby the configurations of the apparatus for transmitting power wirelessly 100 and the apparatus for receiving power wirelessly 200 may be simplified and charging efficiency may be increased.

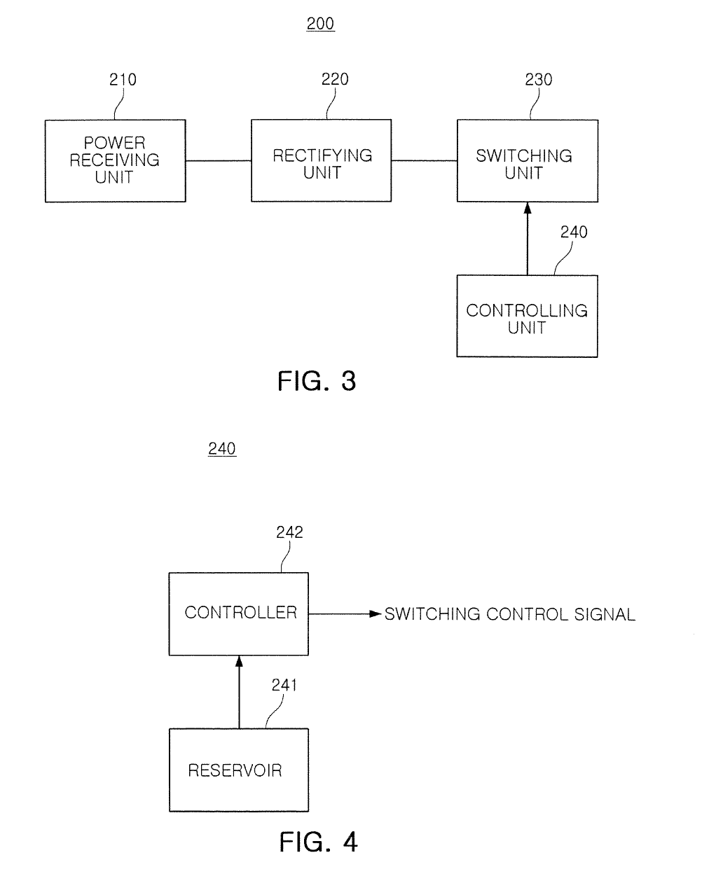

FIG. 3 is a block diagram illustrating an example of an apparatus for receiving power wirelessly according to an exemplary embodiment in the present disclosure.

The apparatus for receiving power wirelessly 200 may wirelessly receive power in the non-contact manner. The apparatus for receiving power wirelessly 200 may adjust a level of a voltage output by the apparatus for transmitting power wirelessly, by adjusting a point in time of resonance with the apparatus for transmitting power wirelessly 100.

The apparatus for receiving power wirelessly 200 may adjust a level of the voltage output by the apparatus for transmitting power wirelessly, by adjusting an operating timing of the resonance circuit.

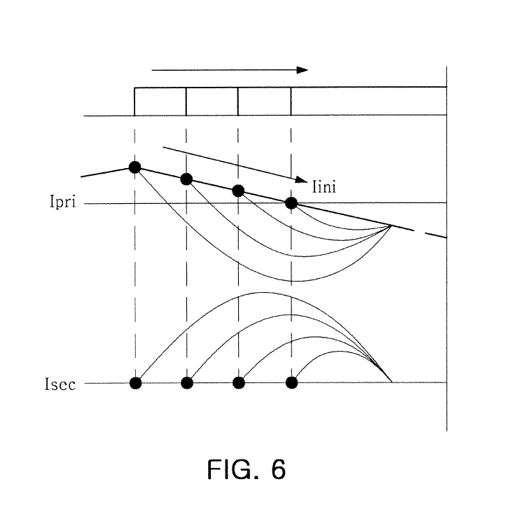

FIG. 6 is a graph illustrating a level of an output voltage depending on an initial value of a resonance current. The adjustment of a level of a voltage output from the apparatus for transmitting power wirelessly, performed by the apparatus for receiving power wirelessly 200, will be described with reference to FIG. 6.

Iₚᵣᵢ illustrated in FIG. 6 indicates a primary current, for example, a current of a power transmitting coil of the apparatus for transmitting power wirelessly 100, and I_{sec} indicates a secondary current, for example, a current of a power receiving coil of the apparatus for receiving power wirelessly 200. Iᵢₙᵢ refers to an initial value of a resonance current.

The relationship between the respective currents may be represented by the following Equation 1.

$${i}_{pri} ( t ) = {I}_{ini} cos ( ω ( t - {t}_{0} ) ) + \frac{{V}_{IN} - {V}_{crini} - {V}_{o} / n}{\sqrt{{L}_{R} / {C}_{R}}} sin ( ω ( t - {t}_{0} ) ) \qquad [ Equation 1 ]$$

where Vᵢₙ refers to an input voltage of the apparatus for transmitting power wirelessly, V_{crini} refers to an initial value of a resonance voltage of resonance capacitors C1, C2, and C3 of the apparatus for transmitting power wirelessly, and Vₒ refers to an output voltage of the apparatus for receiving power wirelessly.

A switching timing illustrated in FIG. 6 is associated with a switching timing of the apparatus for receiving power wirelessly 200. As illustrated in FIG. 6, it may be appreciated that a level of the initial value Iᵢₙᵢ of the resonance current may be differently set depending on a switching ON timing. In addition, it may be appreciated that a level of the current I_{sec} of the power receiving coil is adjusted depending on the initial value Iᵢₙᵢ of the resonance current, and as a result, a level of the voltage output by the apparatus for transmitting power wirelessly is adjusted.

As a result, the apparatus for transmitting power wirelessly 100 may be operated depending on a preset operation, and the apparatus for receiving power wirelessly 200 may adjust the switching ON timing to adjust the level of the voltage output by the apparatus for transmitting power wirelessly. For example, the apparatus for receiving power wirelessly 200 may adjust the level of the initial value Iᵢₙᵢ of the resonance current by adjusting the switching ON timing, to thus adjust the level of voltage output by the apparatus for transmitting power wirelessly.

Referring to again FIG. 3, the apparatus for receiving power wirelessly 200 may include a power receiving unit 210, a switching unit 230, and a controlling unit 240. According to an exemplary embodiment in the present disclosure, the apparatus for receiving power wirelessly 200 may further include a rectifying unit 220.

The power receiving unit 210 may wirelessly receive power in the non-contact manner. For example, the power receiving unit 210 may wirelessly receive power in a magnetic resonance with the power transmitting coil or in a magnetic induction scheme thereof.

The rectifying unit 220 may rectify power wirelessly received by the power receiving unit 210.

The switching unit 230 may enable the power receiving unit 210 to operate. The switching unit 230 may be connected to the power receiving unit 210 in series, to operate or stop the power receiving unit 210.

The controlling unit 240 may control a level of a voltage output by the apparatus for transmitting power wirelessly, by adjusting an ON switching operation of the switching unit 230.

According to an exemplary embodiment in the present disclosure, the controlling unit 240 may adjust the initial value of the resonance current by adjusting the switching ON timing of the switching unit 230. For example, as described above with reference to FIG. 6, the controlling unit 240 may adjust the level of the initial value Iᵢₙᵢ of the resonance current by adjusting the switching ON timing of the switching unit 230.

According to an exemplary embodiment in the present disclosure, the controlling unit 240 may perform controlling so that as the voltage output by the apparatus for transmitting power wirelessly is increased, the initial value of the resonance current is increased. As illustrated in the graph of FIG. 6, as the switching ON timing of the switching unit 230 is fast, the initial value of the resonance current is increased. The reason is that the current I_{sec} of the power receiving coil is increased.

FIG. 4 is a block diagram illustrating an example of a controlling unit of FIG. 3.

Referring to FIG. 4, the controlling unit 240 may include a reservoir 241 and a controller 242.

The reservoir 241 may maintain synchronization information with the apparatus for transmitting power wirelessly 100. The reservoir 241 may store switching synchronization information of the apparatus for transmitting power wirelessly 100. For example, the apparatus for transmitting power wirelessly 100 may perform a switching operation at a fixed frequency and the reservoir 241 may store the synchronization information on the fixed frequency.

The controller 242 may adjust the switching ON timing of the switching unit 230 using the synchronization information. For example, the controller 242 may check an operation timing of the apparatus for transmitting power wirelessly 100 using the synchronization information, and may thus check the level of the initial value Iᵢₙᵢ of the resonance current. Once the level of the initial value Iᵢₙᵢ of the resonance current is checked, the initial value Iᵢₙᵢ of the resonance current corresponding to the voltage output by the apparatus for transmitting power wirelessly may be recognized, and as a result, the switching ON timing of the switching unit 230 may be determined.

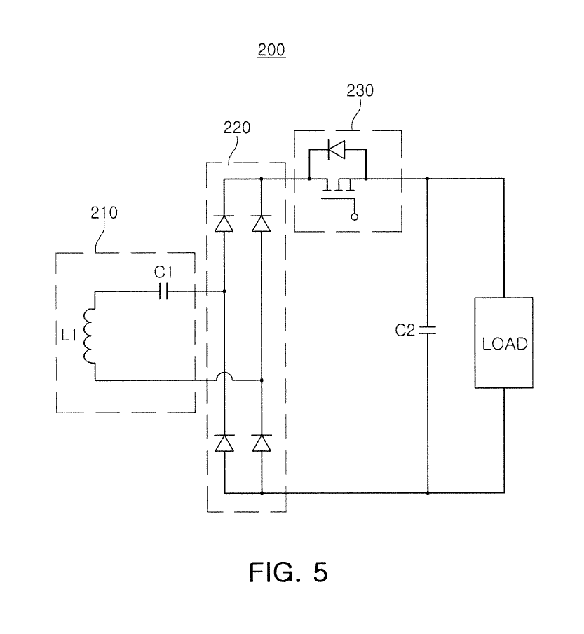

FIG. 5 is a circuit diagram illustrating an example of the apparatus for receiving power wirelessly according to an exemplary embodiment in the present disclosure.

Referring to FIG. 5, the apparatus for receiving power wirelessly 200 may include a resonance circuit 210, a rectifying circuit 220, and a switch 230. The resonance circuit 210, the rectifying circuit 220, and the switch 230 may correspond to the power receiving unit 210, the switching unit 230, and the controlling unit 240 of FIG. 3, respectively.

The resonance circuit 210 may include a power receiving coil L1 and a capacitor C1.

The power receiving coil L1 may wirelessly receive power in the non-contact manner. The capacitor C1 may block a direct current component of the power wirelessly received by the power receiving coil L1.

Although the illustrated resonance circuit 210 is configured as an LC circuit, it may also be configured as an LLC circuit as described above according to an exemplary embodiment in the present disclosure.

The switch 230 may be configured as a single switch connected to the resonance circuit 210 in series. In detail, the switching unit 230 of FIG. 3 may be configured as a single switch.

The reason is that since the level of the voltage output by the apparatus for transmitting power wirelessly is adjusted by determining the operation timing of the resonance circuit 210, the operation timing of the resonance circuit 210 may be determined by only an ON-OFF operation of a single switch. Therefore, according to an exemplary embodiment in the present disclosure, the controlling may only be performed by a single switch without requiring a separate transformer circuit, or the like, and thus, a level of the voltage output by the apparatus for transmitting power wirelessly may be adjusted by a simple and inexpensive circuit configuration.

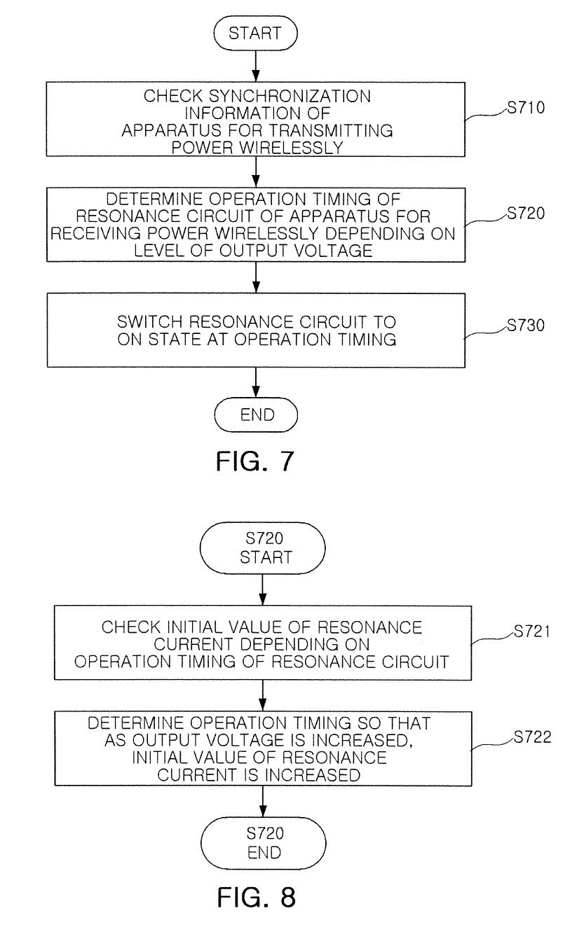

FIG. 7 is a flowchart illustrating an example of a method for receiving power wirelessly according to an exemplary embodiment in the present disclosure. Since a method for receiving power wirelessly is performed in the apparatus for receiving power wirelessly described above with reference to FIGS. 1 through 6, an overlapping description will be omitted.

Referring to FIG. 7, the apparatus for receiving power wirelessly 200 may check synchronization information of the apparatus for transmitting power wirelessly 100 (S710).

The apparatus for receiving power wirelessly 200 may determine an operation timing of the resonance circuit of the apparatus for receiving power wirelessly, depending on a level of a voltage output by the apparatus for transmitting power wirelessly (S720).

The apparatus for receiving power wirelessly 200 may perform controlling so that the resonance circuit is switched on at the operation timing (S730).

FIG. 8 is a flowchart illustrating an example of S720 of FIG. 7.

Referring to FIG. 8, the apparatus for receiving power wirelessly 200 may check an initial value of the resonance current depending on the operating timing of the resonance circuit (S721).

The apparatus for receiving power wirelessly 200 may determine the operation timing so that as the output voltage is increased, the initial value of the resonance current is increased (S722).

As set forth above, according to exemplary embodiments in the present disclosure, a level of the voltage output by the apparatus for transmitting power wirelessly may be adjusted with the simple circuit configuration, whereby production costs may be reduced.

According to an exemplary embodiment in the present disclosure, since the apparatus for transmitting power wirelessly is operated regardless of a control by the apparatus for receiving power wirelessly on the voltage output by the apparatus for transmitting power wirelessly, the configuration thereof may be simplified and production costs may be reduced.

According to an exemplary embodiment in the present disclosure, the apparatus for receiving power wirelessly may exhibit an effect that the number of active elements is decreased to have improved heat characteristics and improved reliability.

While exemplary embodiments have been shown and described above, it will be apparent to those skilled in the art that modifications and variations could be made without departing from the scope of the present invention as defined by the appended claims.

What is claimed is:

1. An apparatus for receiving power wirelessly, the apparatus comprising:
a power receiving unit wirelessly receiving the power in a non-contact manner;
a switching unit operating the power receiving unit; and
a controlling unit controlling an output voltage by adjusting a switching-on operation of the switching unit.

2. The apparatus of claim 1, wherein the controlling unit adjusts an initial value of a resonance current by adjusting the switching-on operation of the switching unit.

3. The apparatus of claim 2, wherein the controlling unit controls the initial value of the resonance current to increase as the output voltage increases.

4. The apparatus of claim 1, wherein the controlling unit includes:
a reservoir maintaining synchronization information with an apparatus for transmitting power wirelessly; and
a controller adjusting the switching-on operation using the synchronization information.

5. The apparatus of claim 1, wherein the power receiving unit includes:
a power receiving coil wirelessly receiving the power in the non-contact manner; and
a capacitor blocking a direct current component of the power wirelessly received by the power receiving coil.

6. The apparatus of claim 1, wherein the switching unit includes a single switch connected in series with the power receiving unit.

7. A wireless power supply system for wirelessly supplying power, comprising:
an apparatus for transmitting power wirelessly transmitting the power in a non-contact manner; and
an apparatus for receiving power wirelessly receiving the power in the non-contact manner and adjusting an output voltage by adjusting a resonance start timing with the apparatus for transmitting power wirelessly.

8. The wireless power supply system of claim 7, wherein the apparatus for transmitting power wirelessly operates at a fixed frequency regardless of the output voltage of the apparatus for transmitting power wirelessly.

9. The wireless power supply system of claim 8, wherein the apparatus for receiving power wirelessly adjusts a level of the output voltage by adjusting an operation timing of a resonance circuit.

10. The wireless power supply system of claim 7, wherein the apparatus for receiving power wirelessly includes:
a power receiving unit wirelessly receiving the power in the non-contact manner;
a switching unit operating the power receiving unit; and
a controlling unit controlling a level of the output voltage by adjusting an switching-on operation of the switching unit.

11. The wireless power supply system of claim 10, wherein the controlling unit adjusts an initial value of a resonance current by adjusting the switching-on operation of the switching unit.

12. The wireless power supply system of claim 11, wherein the controlling unit controls the initial value of the resonance current to increase as the output voltage increases.

13. The wireless power supply system of claim 10, wherein the controlling unit includes:
a reservoir maintaining synchronization information with an apparatus for transmitting power wirelessly; and
a controller adjusting the switching-on operation using the synchronization information.

14. A method for receiving power wirelessly performed in an apparatus for receiving power wirelessly, the method comprising steps of:
checking synchronization information of an apparatus for transmitting power wirelessly;
determining an operation timing of a resonance circuit included in the apparatus for receiving power wirelessly, depending on a level of an output voltage; and
controlling the resonance circuit so as to be switched to an ON state at the operation timing.

15. The method of claim 14, wherein the step of determining the operation timing of the resonance circuit comprises steps of:
checking an initial value of a resonance current depending on the operation timing of the resonance circuit; and
determining the operation timing so that as the output voltage is increased, the initial value of the resonance current is increased.
